(19) United States
(12) Patent Application Publication
(10) Pub. No.: US 2026/0285527 A1
(43) Pub. Date: Sep. 24, 2026

(54) METHOD FOR OPERATING A PRODUCTION LINE

(71) Applicant: Weber Food Technology SE & CO. KG, Breidenbach (DE)

(72) Inventor: Michael BRANDT, Eschenburg (DE)

(21) Appl. No.: 19/478,424

(22) PCT Filed: Apr. 5, 2024
(86) PCT No.: PCT/EP2024/059349

§ 371 Date: Dec. 3, 2025

(30) Foreign Application Priority Data
Apr. 26, 2023 (DE) 10 2023 110 816.6

(51) Int. Cl. B65B 57/00; B65B 5/08; B65B 61/00

(52) U.S. Cl. CPC B65B 57/00; B65B 5/08; B65B 61/005

(57) ABSTRACT

The invention relates to a method for operating a production line which comprises one or more modules and in which food products are cut into slices, portions are formed from one or more slices in each case, and the portions are packaged, and said production line at least comprises a slicing apparatus, in particular a high-performance slicer, for slicing the products and for forming the portions; a packaging machine for packaging the portions; between the slicing apparatus and the packaging machine, a transport path for handling the portions; and a control device, wherein the production line further comprises at least one sensor for monitoring at least one protected region associated with the production line, wherein the sensor provides sensor data relating to the monitoring for the control device, and wherein the control device recognizes a special situation in the protected region based on the provided sensor data, assesses the recognized special situation and, depending on the result of the assessment, adapts a movement of at least one module or of at least one component of a module of the production line.

### RELATED APPLICATION

The present application is a national stage application under 35 U.S.C. § 371 of International Application No. PCT/EP2024/059349, filed 5 Apr. 2024, which claims priority from German Patent Application No. 10 2023 110 816.6 filed 26 Apr. 2023. The above-referenced applications are incorporated by reference.

### SUMMARY

The invention relates to a method for operating a production line which comprises one or more modules and in which food products are cut into slices, portions are formed from one or more slices in each case, and the portions are packaged, and said production line at least comprises a slicing apparatus, in particular a high-performance slicer, for slicing the products and for forming the portions; a packaging machine for packaging the portions; between the slicing apparatus and the packaging machine, a transport path for handling the portions; and a control device.

The invention furthermore relates to a production line in which food products are cut into slices, portions are formed from one or more slices in each case, and the portions are packaged, and said production line at least comprises a slicing apparatus, in particular a high-performance slicer, for slicing the products and for forming the portions; a packaging machine for packaging the portions; between the slicing apparatus and the packaging machine, a transport path for handling the portions; and a control device.

Such production lines and operating methods therefor are generally known in the field of processing food products, in particular meat, sausage and cheese, that is relevant here.

In most cases, the modules of a production line of the kind in question here have movable parts that can pose a potential danger to operators, but also to other modules or components of the line or to external objects. Whether a specific movement represents a potential hazard or not can depend on the situation and on the properties of the movement, for example the speed, the effective forces or the sequence of the movement. Distances between the components of the line that change due to the movement can also determine whether a situation exists that is to be classified as a potentially hazardous state or as another state that requires special measures.

Such special situations, which can in particular pose a risk to persons or objects, can be present permanently in practice and thereby in particular directly in the region of the line. Alternatively or additionally, situations can arise in practice that only occur in phases. A component of a module or even just a part of a component can project permanently or in phases into an, for example lateral, environment of the line. A walkway for operators or a driveway for, for example, automatic conveyor vehicles can hereby be temporarily endangered.

It is known to provide modules or components of modules with enclosures in order to protect objects, i.e. persons and objects that are not part of the line, from hazards in this way. Typically, such enclosures are provided with sensors that, for example, monitor the positions of doors or other access devices. If such an enclosure is opened during the operation or at any other impermissible time, the respective module or the entire line will be stopped. Even if the standstill only occurs at a single module, this can quickly lead to a standstill of the entire production line due to the functional interlinking, which usually exists in practice, of the modules interacting in the line. The high production speeds of such lines that have now been achieved are also problematic in this respect. These high speeds mean that, in the event of a malfunction, not only the respective module, but rather the entire line has to be shut down for safety reasons and also in order to maintain the production on restarting the line. It is furthermore necessary for an operator to acknowledge the restoration of a safe state after an interruption so that the line can resume its operation again.

The enclosures mentioned indeed meet a high level of safety, but they cannot be used on all the modules since they cannot be used flexibly and require a lot of space. Labeling devices or printing devices that are used at packaging machines are, for example, particularly unsuitable for enclosures since such devices are moved along the packaging machine during the operation. To comply with applicable safety regulations, such labeling devices or printing devices can only be operated at certain speeds, wherein minimum distances must furthermore be maintained so that operators are not endangered.

With such devices, it is therefore endeavored to avoid enclosures as far as possible since they are very disadvantageous in terms of access options and space requirements.

Regardless of the respective specifically affected module of a production line, an operating interruption is always a disadvantage. Not only can this lead to an uncertainty for operators, but an interruption in any case requires additional work steps by operators who must ensure after an interruption that the line resumes proper operation again. It is also disadvantageous that operating interruptions mean high mechanical loads since such safety shutdowns usually occur abruptly so that the respective components, which often have a large mass, have to be decelerated suddenly.

In particular in the field of the processing of foods, operating interruptions have the further disadvantage that the dwell time of the food products in the line is hereby increased. Due to legal regulations, if a dwell time is too long, it may be necessary to remove all the food products from the line, i.e. to clear the entire line, whereby waste results. Even if this problem does not affect the entire line, the aim is to avoid such waste. For example, waste can occur at a molding station or a sealing station of a packaging machine due to the thermal influences prevailing there. If the line comes to a standstill, the products remain in the molding or sealing station for too long so that they are heated too much due to the temperatures prevailing in these stations, which may violate hygiene regulations. A further disadvantage of too long a dwell time is that the films or other material webs used for the packages can become unusable if they are heated for too long.

It is therefore the object of the invention to improve a method and a production line of the initially mentioned kind such that as efficient as possible an operation of the production line with a maximum protection for persons and objects directly at the line and in its environment is made possible.

In the method according to the invention, it is provided that the production line further comprises at least one sensor for monitoring at least one protected region associated with the production line, wherein the sensor provides sensor data relating to the monitoring for the control device, and wherein the control device recognizes a special situation in the protected region based on the provided sensor data, assesses the recognized special situation and, depending on the result of the assessment, adapts a movement of at least one module or of at least one component of a module of the production line.

In the production line according to the invention, it is provided that the production line further comprises at least one sensor for monitoring at least one protected region associated with the production line, wherein the sensor is configured to provide sensor data relating to the monitoring for the control device, and wherein the control device is configured to recognize a special situation in the protected region based on the provided sensor data, to assess the recognized special situation and, depending on the result of the assessment, to adapt a movement of at least one module or of at least one component of a module of the production line.

The invention is based on the idea, if a special situation is present, which is, for example, assessed as a hazardous situation or as another situation requiring a measure of any kind, of not temporarily stopping or shutting down the production line or a part thereof as before, but of rather adapting the movement to the respective situation. For example, in a hazardous situation, the movement of one or more parts, for example, of a module or of a component of the module, can be slowed down.

Among other things, the invention is based on the realization that a slow operation of the line can be advantageous for many reasons compared to a standstill, even only a temporary standstill, of the line.

As already initially mentioned, the special situation can in particular be a hazardous situation. In principle, other situations that require an adaptation are also conceivable. The special situation can, for example, involve an object (a human, a body part of a human, an object belonging to the line or an external object) being in a place or a position where this object does not belong. In particular if the object is a human or a body part of a human, this special situation will usually have to be assessed as a hazardous situation. A special situation can also involve one or more components of the production line assuming a non-intended position, or a plurality of components at least temporarily not being in intended relative positions to one another. Such situations do not have to be assessed as hazardous situations, but can be assessed as disruptive situations or situations to be avoided that require a specific measure. Such a measure, for example the elimination of a fault, can be designed such that a standstill of the line is not required for this purpose, but that it is sufficient, for example, to move the respective module or the respective component more slowly only temporarily, without having to temporarily stop the production operation of the module or of the entire line in the process.

A protected region that is associated with a respective sensor or a plurality of sensors can be an internal protected region that is located directly at a module or a module component or that is disposed directly between a plurality of modules or components of the line. For example, a hazardous situation can arise in that modules or components that are movable relative to one another do not maintain minimum distances that have to be maintained based on operational requirements or legal regulations. A hazardous situation can also comprise persons or objects entering such a protected region located directly on the production line.

Alternatively, the protected region can be an external protected region that relates to the environment of the production line, for example, a walkway or a driveway next to the line.

As explained in more detail elsewhere, the protected region can be divided into a plurality of protected zones. It is also possible that a respective protected region is associated with a plurality of modules. Furthermore, it can be provided that a respective protected region is monitored by either one or more sensors.

As is also already clear from the above statements, the movement that is adapted in dependence on the result of the assessment can be a movement of, for example, a module or a component of a module that takes place at a certain speed or with a certain acceleration. The movement can, for example, take place along intended travel paths. However, the movement can also be a movement of such a kind that it cannot be accurately predicted. Working movements of a pick-and-place robot (picker) can, for example, inter alia depend on the specific position of the portions to be picked up and are also intended even if they cannot be predicted exactly in every respect.

The adaptation of the movement can in particular be a reduction of the speed of the movement. However, the adaptation is not restricted to this. Positive accelerations, for example, of modules or module components can also be changed to achieve an adaptation of the movement in this way.

If one or more modules or a larger unit of the entire production line, such as the packaging machine, is operated in a clocked manner, an adaptation of one or more movements can comprise reducing or increasing the clock frequency, i.e. the number of work cycles per unit of time can be changed.

Furthermore, an adaptation of the movement can, for example, also take place by shortening travel paths of one or more modules or of one or more components thereof or by increasing minimum distances to be maintained between components of the production line.

The assessment of a special situation can e.g. always take place in the same way or can be variable. In the latter case, for example, the same situation, e.g. the intrusion of an object into a protected region, can be assessed differently depending on whether the object is a permissible or an impermissible object. A permissible object can, for example, be an arm of an operator who is recognized as such by suitable means, wherein an arm, which intervenes in the same way, of a person who is not recognized as an operator is assessed as a non-permissible object whose intrusion consequently results in an adaptation of the movement, for example, a slowing down of a moving module to reduce a risk of entrapment.

In the case of an operator as a permissible object, it can, for example, be assumed that the operator is aware of the potential hazard so that no adaptation of the movement takes place. In this example, a distinction can additionally be made according to the kind of intrusion, for example, if the protected region is divided into a plurality of protected zones. In the event of an intrusion into an inner protected zone disposed the closest to a potentially dangerous point of the line, an adaptation of the movement can, for example, take place regardless of whether an object is impermissible or not so that, for example, operators are also reliably protected.

An assessment concept can, for example, also comprise different guidelines or criteria applying to different modules or module components. A situation that is recognized and assessed as a special situation for the one module does not necessarily likewise have to represent such a special situation for another module. Alternatively or additionally, the same special situation can be assessed differently for different modules.

Due to such assessment concepts, different hazardous situations can be defined for different modules in the protected region. This may be required or predefined for design or operational reasons. For example, one module can allow a faster deceleration to a non-critical value that is no longer considered dangerous than another module that cannot be decelerated so quickly, e.g. for technical design reasons.

An assessment of a certain special situation can change over time. In particular, the control device itself can learn or be taught. If, for example, an operator at the production line is recognized and assessed as an impermissible object when it is first recognized, but this operator is wearing specific work clothing which is initially unknown to the control device and which can be clearly identified by the sensor, on a subsequent recognition of this specific work clothing, an assessment can take place to the effect that this object, i.e. the operator or, for example, an arm or a hand of the operator, is not assessed as an impermissible object.

Specific work clothing can be recognized, for example, by its coloring or by a certain color combination. White outerwear in combination with colored work gloves, for example, can be reliably distinguished from the clothing of visitors or other persons not authorized to work on the production line.

For example, the control device can use AI-based software (AI=artificial intelligence) for such a recognition and assessment of special situations.

The modules in the production line can, for example, be the following devices:
a processing apparatus, e.g. a bacon press or a cheese divider (product preparation),
a scanning apparatus, for example, a scanner for determining the outer contour and/or a scanner, e.g. an X-ray scanner, for determining the inner structure of the food products,
a loading device for product bars, e.g. a loading rocker, a single-cycle apparatus or a loading magazine,
a slicing apparatus, in particular comprising
   a driven cutting blade,
   a lockable cutting head comprising a cutting blade and a drive for the cutting blade,
   an adjustable cutting edge for setting the cutting gap,
   an interleaver,
   a height-adjustable and/or side-adjustable portioning unit,
   a product gripper, in particular having a settable holding force, for example a vacuum gripper,
   a scale,
   an underleaver,
a transport path comprising conveying apparatus, sorting apparatus, buffering apparatus and insertion apparatus, the latter for example in the form of insertion robots (in particular pickers, i.e. pick-and-place robots),
a packaging station comprising
   a molding station, e.g. a deep-drawing station such as a thermoforming machine,
   an insertion region (works together with insertion apparatus of the transport path to insert portions into recesses/trays),
   a sealing station,
   a labeling station/labeling device for applying labels to the packages,
   a printing station for printing the packages and/or labels,
   separating devices, in particular longitudinal and transverse separating apparatus for separating the packages.

The sensor or the sensors can generally be attached at any desired point of the production line, for example at a labeler. Further possible modules that have movable parts should be mentioned purely as examples: pressure axles, film rollers, transversely movable belts, picker robots, comparatively small robots for inserting additives such as mustard bags in a so-called ready meal region, rockers, stackers.

As already expressed elsewhere, the invention makes it possible to adapt one or more movements of modules or module components taking place on the production line, and thus in particular to control the performance, which results from these movements, of the modules concerned or of the production line as a whole in dependence on the sensor data. A balance between the technically possible movements or speeds, on the one hand, considering safety aspects, on the other hand, can hereby be advantageously provided. The safety aspects can relate both to the module or the production line itself and to external influences, in particular to the entry of external objects into a respective protected region.

In this context, it should be emphasized that, due to the invention, it is not only possible to slow down the operation of a module or of the entire production line if a recognized special situation is assessed as a hazardous situation, for example. Rather, it is also possible to operate one or more modules or the entire production line with a higher performance in terms of being faster, i.e. with faster movements, than is currently possible for safety reasons. Legal regulations, for example, can require that certain speeds or accelerations of movable parts of a production line may not be exceeded, even though this would be technically possible without disadvantages for the line or the respective module. Due to the monitoring provided according to the invention and the possibility of influencing the movements taking place on the line, a rapid operation can, for example, be made possible if there are no persons and no improper or impermissible objects in the respective protected region or in all defined protected regions of the line.

A significant increase in performance compared to the current possibilities can hereby be achieved without having to correspondingly reinforce the production line itself. If the current situation in each protected region is therefore assessed as safe or as particularly safe, the production line can, for example, be operated purely according to efficiency or to performance criteria with respect to each module, i.e. the production line can be “maxed out”, which was previously not possible for safety reasons.

The aim of maintaining predefined safety distances can in particular be achieved by an adaptation of the movement.

On the one hand, this can refer to distances between the respective movable part of the production line and adjacent components. It is hereby, for example, possible for the movable part to approach another component at a maximum speed until a minimum distance within the meaning of a so-called gap dimension is reached. A minimum distance can, for example, result from a risk of entrapment that is relevant for humans or certain body parts of humans. Irrespective of this—and thus to a certain extent from the perspective of the operation of the production line—permissible gap dimensions can arise with regard to a risk of collision from components, taking into account braking processes and braking distances. A practical example of this is a labeler of a packaging machine, which comprises a so-called top labeler as one module and a so-called bottom labeler as another module, wherein the former applies labels to a top film of the packages and the latter serves to apply labels to the bottom film. In practice, these two modules are moved independently relative to one another on one or more travel axes in a labeling region of the packaging machine that belongs to the production line. Since, due to the monitoring of appropriately arranged protected regions, the invention can ensure that minimum distances between the two modules or between one of the two modules and a further module or a component thereof, such as the housing of a sealing station disposed upstream of the labeler, are maintained, the travel speed of the labeler modules can be increased since a slower operation than standard, which considers the potential entry of objects, does not have to be provided as a precaution.

Using the example of such a labeler, a further advantage of the invention can be emphasized that comprises further special situations being recognizable beyond a position control of the respective movable part—in this case the top labeler and the bottom labeler of the labeler along the one or more travel axes mentioned. A special situation can, for example, result from a changed outer contour of the top labeler or the bottom labeler. For example, a relative position of a component, for example an outwardly folded label supply roll, that is not as intended can be recognized by a sensor. If, in such a position, which is actually a maintenance position, an operation of the respective module—in this case the labeler—is nevertheless possible, the production line does not need to be temporarily stopped to be able to fold back the label supply roll, but the production line can be temporarily operated, e.g. until a new label supply roll is inserted, at a reduced speed since the region of the folded-down label supply roll, from which a potential hazard can emanate, can be monitored. Such a temporary slowing down of the production line can be advantageous for a variety of reasons compared to a standstill—even an only brief standstill—of the production line.

On the other hand, the invention can also ensure that safety distances between a respective movable part and external objects (persons or objects) are maintained. The operation of the production line can therefore be made dependent on whether such external influences are present in a defined environment of the production line or not.

It has already been explained above as an example that a “fast operation” can be carried out, e.g. if the environment of the production line is recognized as free.

If a person or an obstacle is recognized in the environment of the production line, such as an automatic conveyor vehicle in a travel path next to the line, the production line does not need to be stopped, but can be slowed down accordingly depending on the specific situation. This not only protects the recognized person or the recognized object, but also results in a gentler operation compared to an abrupt standstill of the line. Abrupt deceleration processes can lead to wear or vibrations in the production line or individual modules that can shorten the service life of the affected components when considered over a long operation period. In other words, the invention enables a running through of the production line and thus, overall, a smaller load on the modules and components, in particular on the movable parts.

The control device can be configured, based on the provided sensor data, to distinguish, for example, humans, on the one hand, and objects, on the other hand from one another in that humans and their body parts are recognized based on the respective outline and are distinguished from objects in this manner. In this way, it is possible to carry out differentiated assessments and/or to take differentiated measures with respect to an adaptation of the movement.

It has already been mentioned elsewhere that the control device itself can learn or be taught. As explained, this can comprise recognizing specific work clothing. However, it is also possible to assess certain special situations only through teaching as a situation that does not require a movement adaptation. For example, an outwardly folded label supply roll, as already mentioned above, which is thus in a maintenance position and, for example, projects outwardly laterally beyond the line, can be assessed by a taught control device as a permissible operating state that does not lead to a movement adaptation, whereas, when this special situation is recognized for the first time, an assessment is made to the effect that a potentially hazardous situation is assumed and a movement adaptation must therefore be carried out.

As far as such, in particular AI-supported, learning processes of the control device are concerned, the invention can utilize the circumstance that the same conditions usually prevail in production plants in every work shift. This applies, for example, to the specific work clothing already mentioned that can be learned by the control device as a recurring phenomenon that is thus to be assessed as permissible. However, this also applies to other situations, for example, recurring features of certain objects. For example, the shape, size or color of stationary objects such as crates or of movable objects such as conveyor vehicles can be recognized by the control device and, with the knowledge that these objects may actually be located where they are recognized by the control device during an intended operation, can be assessed as permissible so that an adaptation of the movement does not take place.

In this respect, an assessment by the control device does not have to take place based exclusively on such features such as shape, size or color. These features can, for example, supplement the final assessment that may actually take place based on a larger information basis. An optimization of the assessment process can hereby be ensured.

Some specific examples are specified below.

If, for example, a human is recognized in the protected region, the respective module or the entire production line can reduce its performance within the meaning that one or more movements of movable parts of the line take place slowly. In addition, a warning signal can be output, for example. If the person moves out of the protected region again, it can be provided that the production line automatically increases the speed of the movement or the movements again—and not only after an explicit acknowledgment by an operator.

Although the invention is therefore particularly advantageous since an automatic standstill of a module or of the entire production line can be prevented if this is not absolutely necessary, within the scope of the invention, an assessment of a special situation can as an “ultima ratio” also lead to the movement being adapted such that, for example, the speed is reduced to zero, i.e. the module or the entire production line is stopped. In this case, too, the restarting of the line can take place automatically once the special situation or the corresponding assessment has ceased.

According to a further application example, the protected region can be divided into a plurality of protected zones. Whereas, on an intrusion into a protected zone disposed on the outside, the movement is only slowed down and a warning signal is possibly output, a greater reduction in the speed or even a standstill of the respective module or of the production line can take place in the event of a violation of a protected zone disposed further inside.

It can also be provided that, in the event of a division into a plurality of protected zones, an intrusion into a protected zone disposed on the outside, in particular into the outermost protected zone, does not yet result in a movement adaptation, but rather another measure takes place, in particular an e.g. optical and/or acoustic warning. Such a warning can e.g. only take place when persons recognized as such intervene in the outer protected zone in order, by means of this warning, to prevent an accidental (further) movement of the respective person into a further inwardly disposed protected zone, which would then necessarily result in a movement adaptation. If, on the other hand, an object is recognized in the outer protected zone, it can be provided that no warning takes place (since it is assumed that objects, unlike humans, cannot be warned or cannot be warned easily), but that a movement adaptation takes place immediately.

If different protected zones are provided, they can be checked by means of a reference run of the module or of the entire production line and can be corrected if necessary. A change resulting from this can be taught into the control device. A teaching can also take place after modifications have been made to the production line.

It is also possible to store or to teach-in certain protected regions or divisions of a protected region into certain protected zones such that they can be called up, for example in a memory device of the control device, in order thus to be able to proceed according to a recipe. In the field of food processing in question here, different applications that in particular differ from one another with respect to the kind of food products to be processed and/or the manner of the processing are referred to as “recipes”. A respective recipe is therefore also characterized by corresponding settings at the modules and module components of the production line. Different recipes can, for example, require different protected regions, different protected zones into which a respective protected region is possibly divided, or different assessments of certain special situations.

For example, a change to a different food product can necessitate a different package geometry that, for example, no longer requires the entire travel region of a labeler that is available in principle. A smaller protected region is then sufficient. In this respect, it can then also occur that, with a correspondingly reduced travel path of the labeler, there is no risk of collision with respect to further modules or components and no risk of entrapment for operators either since critical gap dimensions can no longer occur in such an application due to the shorter travel path alone.

Depending on the function of a respective module, it may be possible that only the respective module in question is slowed down or stopped, if necessary, so that the production line can continue to be operated apart from this. This is possible, for example, if the respective module is a rocker or a stacker. Downstream of such a module, the packaging of portions at the packaging machine can continue without disadvantages at least for a certain time period.

According to further examples, the movement adaptation can take place in a distance-dependent, speed-dependent or direction-dependent manner. These criteria can generally also be combined with one another as desired.

In a distance-dependent reaction to a special situation, the extent of a change in the movement, in particular a slowing down of the movement, can take place in dependence on the distance of a respective object (human or object) from a module or a module component. If the object is a human, in particular the potential risk of entrapment is included as a relevant criterion in the assessment of the special situation by the control device.

In a speed-dependent reaction, the control device can, for example, differentiate a stumbling of a human from a normal, slow walking. For example, a stumbling can be recognized as a fast movement towards the machine and can accordingly be assessed as critical so that such a special situation can even lead to an immediate stop of the production line and not just to a slowdown of the respective movement. A slow walking movement, on the other hand, can be assumed to be a normal state so that, in the case of a corresponding proximity of the walking human to the production line, a slowing down of the movement can be sufficient for safety reasons and no standstill is required.

In a direction-dependent assessment, it can, for example, be distinguished by the control device whether a person is walking along the production line parallel to the transport direction, which only leads to a slowing down of the respective movement of the module, the module component or the entire production line if the person is comparatively close to the production line in this respect. If, on the other hand, it is recognized that a person is moving towards the production line, i.e. the recognized movement does not take place parallel to the transport direction, a more pronounced reduction of the speed or even a standstill of the production line can take place.

The above-mentioned possible dependencies of a reaction with respect to distance, speed and direction can analogously also apply to objects in a respective defined protected region. In this respect, it can be provided that lower safety requirements apply to objects insofar as an object that initially enters the protected region but then no longer moves and comes to a standstill has the result that the slowing down of the movement is reversed as long as the object is not located so close to the respective module or the respective component that it is endangered by the movable part. In other words, smaller safety distances can apply to objects than to humans.

After reducing the speed of the movement of a movable part of the production line, the resumption of the original movement can, for example, be controlled by distance or time. For example, a resumption of the normal operation can take place as soon as the respective object has moved sufficiently far away from the respective module. If a sufficiently large distance from the object is not reached, a resumption of the normal operation can nevertheless take place if a predefined time period has elapsed without the object having approached the respective module again since it is assumed in this case that a re-approach is sufficiently unlikely. A sufficiently large safety buffer can hereby be provided that minimizes the risk that a movement adaptation has to take place again a short time after the resumption of the normal operation since the respective object causes a special situation that is assessed as critical.

The sensor can be attached to a movable module or integrated into it so that the sensor moves together with the module. The advantage here is that the module, regardless of its position, is always provided with the same protected region and, if necessary, the same division into protected zones.

Alternatively, the sensor can be permanently installed in order, for example, to monitor a protected region that is best protected with respect to the production line and that is associated with a working region of a respective module or a respective module component. The sensor can, for example, be arranged above a working region or movement region of the module or the component. A lateral offset is also possible such that a perspective monitoring of the working or movement region is realized.

The sensor can furthermore in particular be aligned with respect to predefined walkways, access regions or hazardous regions such that the respective movable module or the respective movable module component is always in the background of the monitored protected region and any objects entering the protected region are always in the foreground.

A sensor can, for example, be checked from time to time using reference images. A reference image can correspond to a predefined operating state of the respective monitored module or of the respective monitored component. If the control device correctly recognizes and assesses such predefined situations, it is not necessary to use additional test objects or “test interventions” by humans to test a sensor.

In addition to one or more sensors in the region of the production line, further sensors can be provided elsewhere. For example, a camera can be attached to a hall ceiling. Additional information can be obtained by means of such a sensor and can, for example, be used to adjust the protected regions of sensors arranged on the production line. Depending on an overall situation recognized by means of the additional sensor, certain default values that relate to a sensor arranged on the production line can, for example, also be changed or activated in the first place.

The invention enables an efficient operation of the production line and thus a higher output with a simultaneous high level of safety for persons and objects. Furthermore, a greater flexibility can be achieved at the modules and their components since the movements taking place as intended at the modules or components can be adapted to the respective situation.

Since enclosures of modules or components can be avoided by the invention, the invention enables easier access to individual modules, whereby in particular maintenance and conversion are simplified.

Due to the invention, more freedom in the environment of the production line furthermore results. Walkways and driveways in the environment of the production line can be better utilized since the risk of the production line being stopped automatically does not exist from the outset for every object moving there.

As already mentioned elsewhere, the invention ensures that frequent stops of the production line, which in most cases are not actually necessary, and a resulting restarting are avoided. This means that the production line can be operated virtually continuously so that the entire production remains reliably “in flow”.

The operating and monitoring effort as well as measures after stops of the production line by operators, which can also be accompanied by uncertainty for operators, are avoided. Overall, a relevant relieving of operators hereby results.

Due to the monitoring provided according to the invention, possibly occurring errors can immediately be localized. Time-consuming troubleshooting by operators is no longer necessary. It should be taken into account here that production lines can have a considerable length in practice, which would make troubleshooting very time-consuming.

As already mentioned elsewhere, a further advantage of the invention is that the monitoring and thus the assessment can take place depending on the recipe so that an optimum monitoring concept can be provided for each specific application.

Possible further developments of the invention are also set forth in the following description and in the drawing. Examples of some of the further developments of the invention explained below are also specified above.

It can be provided that the protected region is fixed or variable relative to the production line, in particular to a module or a component of a module.

The protected region can, for example, be designed to “move along” in that the protected region is fixed relative to a first module or a first component and is thus movable relative to a second module and a second component relative to which the first module or the first component moves during the operation.

In some embodiment examples, a special situation can be recognized by the sensor data deviating from predefined sensor data, in particular previously taught sensor data.

It is hereby made possible that a current situation can be compared, in particular continuously, with one or more situations known to the control device.

It can be provided that the assessment of a special situation by comparing it with at least one predefined situation, in particular a previously taught situation, takes place.

In this respect, it can be provided that the predefined situation is changed based on at least one assessment of the same special situation that took place previously or that the assessment of the special situation takes place differently based on at least one assessment of the same special situation that took place previously.

It is hereby made possible for the control device to learn itself or for the control device to be taught.

The special situation can be a hazardous situation in which a person or an object belonging to the production line or an external object not belonging to the production line is exposed to an at least potential danger by a module or by a component of a module of the production line.

For example, the top tool of the sealing station can potentially be endangered by a top labeler of the labeler, said top labeler being located upstream. According to an alternative example, a module or component can have different positions and can only represent a potential hazard in one position. For example, a label supply roll that is laterally folded down for a roll change and that allows an operation of the production line in the folded-down state without an error message can nevertheless be potentially dangerous in this folded-down state since it laterally projects from the production line and, for example, projects into a corridor next to the line.

In this respect, the at least potential danger can emanate from at least one movable part of a module or a component of a module.

In some embodiments, it can be provided that, if a predefined minimum distance between parts of the production line that are movable relative to one another is not maintained in the protected region, this is recognized as a special situation.

As already mentioned elsewhere, for example at a labeler, the top labeler and the bottom labeler can be movable relative to one another and/or relative to other modules or module components, wherein minimum distances within the meaning of gap dimensions are to be maintained in order to avoid a risk of entrapment for operators.

According to some further developments, the entry of an object into the protected region can be recognized as a special situation.

Furthermore, it can be provided that an assessment of a special situation takes place in dependence on one or more additional predefined conditions and/or in dependence on whether at least one predefined situation has been recognized in the same or a further protected region or not.

If, for example, there are no persons in the region of the production line or a specific module, a predefined minimum distance to be maintained can be selected smaller than if persons are present. The movement adaptation can consequently be made dependent not only on the special situation itself, but also on the additional conditions under which the respective special situation occurs.

In some embodiments, at least one additional predefined criterion can be considered for an assessment of a special situation, in particular wherein the additional predefined criterion can be detected by the sensor monitoring the respective protected region.

For example, the presence of a person in the protected region or the intrusion of a body part of a person in the protected region can be recognized as a special situation. If, for example, a camera forming the sensor can additionally detect the color of a certain part of the clothing or the presence of an authorization (e.g. a visual badge), the person can then either be assessed as authorized, for example within the meaning of being instructed in the operation of the production line, which results in no or at most a slight slowing down of the movement. Or the person can be assessed as unauthorized, which results in a sharp slowing down of the movement or an immediate stop of the production line or of the respective component.

A plurality of operating modes can be predefined for at least one module or at least one component of a module and the movement adaptation can take place in that the control device initiates a change from a current operating mode to another operating mode of the module or the component.

In some embodiment examples, it can be provided that the control device reverses the movement adaptation as soon as the special situation is no longer recognized.

For example, on an intrusion of an object into the protected region, the speed of a module at which the intrusion takes place or the speed of the entire production line can be reduced and—as soon as the protected region is no longer violated—can be increased again. This reversing can be made dependent on a confirmation from an operator who must so-to-say acknowledge the “free state”. However, this is not mandatory, i.e. the reversing of the movement adaptation can also take place automatically. It can also be provided that an acknowledgment is only required for certain special situations.

The reversing of the movement adaptation can take place with a delay. In this respect, the delay can be determined by the expiry of a predefined time period or by the reaching of a minimum distance of an object, which previously triggered the movement adaptation, from the protected region.

According to some further developments, the movement adaptation can take place by a slowing down of the movement, in particular wherein the slowed-down movement is always maintained above zero unless a predefined emergency situation is recognized in which the control device stops the production line or at least one module of the production line.

As mentioned elsewhere, the concept of keeping the production line “always in motion”, so to speak, is of a particularly advantageous significance in the field of the processing of foods. Due to legal regulations, it is often necessary to package the portions produced when slicing the food products within a certain time. A standstill of the line would increase the dwell time of the portions in the line. If the dwell time is too long, it would be necessary to remove all the portions from the line and to restart the line operation. The risk of such interruptions can be minimized by the invention.

According to some embodiments, it can be provided that the movement adaptation takes place in that a movement sequence of a module or of a component of a module is changed, said movement sequence forming part of the intended operation.

Within the meaning of the present disclosure, a movement is not necessarily only a movement taking place along a path, for example, a rectilinear path or a curved path. Rather, a movement can also comprise a movement sequence, for example a back and forth movement, or even more complex movement sequences that can in particular also take place in three dimensions.

It can be provided that the movement adaptation takes place in that a speed or an acceleration of a movement of a module or of a component of a module is reduced or increased.

Alternatively or additionally, it can be provided that the movement adaptation takes place such that at least a minimum distance to be maintained between parts moving relative to one another is increased.

In some further developments, the protected region can be divided into a plurality of protected zones and, depending on which protected zone or which protected zones is/are affected by a recognized special situation, the special situation is assessed differently and/or the movement adaptation is performed differently.

Such a protected zone concept in particular provides the possibility of an escalation such that, for example, the closer an object comes to the line or the faster an object moves towards the line, the more the movement is slowed down.

In general, i.e. even without a protected zone concept, the movement adaptation can take place in dependence on the position of an object in the protected region and/or on the distance of an object located in the protected region from the production line, from a module or from a component of a module.

In this respect, the control device can, for example, proceed according to the concept according to which the closer the object is to the production line, the more slowly the movement takes place.

It can be provided that the movement adaptation takes place in dependence on the speed of an object in the protected region.

As already mentioned elsewhere, for example, a person walking slowly can be assessed as uncritical, whereas a person running or even stumbling can be recognized as such and assessed as critical.

According to some further developments, it can be provided that the movement adaptation takes place in dependence on the direction of a movement of an object in the protected region relative to the production line.

As already explained above, a person walking close to but parallel to the line can be assessed as uncritical, but a person moving towards the line can be assessed as critical.

In some embodiments, it can be provided that a plurality of sensors for monitoring a common protected region are provided and a special situation in the common protected region can be assessed based on the sensor data of the plurality of sensors, or it can be provided that the production line comprises a plurality of sensors for monitoring different protected regions and either a special situation in one of the protected regions or a special situation relating to a plurality of protected regions is assessed as an overall situation based on the sensor data of a plurality of sensors.

Alternatively, it is also possible for one sensor to monitor a plurality of protected regions. If, for example, a protected region is associated with each module, one sensor can consequently monitor a plurality of modules.

The control device can be configured to evaluate sensor data provided by a plurality of sensors that monitor the same protected region or different protected regions.

In some further developments, it can be provided that additional data are provided for the control device and the control device includes the additional data in the assessment of the special situation, in particular wherein the additional data relate to information about the production line, about at least one module of the production line, about at least one component of a module and/or about the environment of the production line.

The additional data can, for example, be provided by an additionally provided sensor system that relates to the production line, to a module or to a component of a module. Alternatively or additionally, this sensor system can relate to devices of the environment of the production line, for example, to devices of the room or the hall in which the production line is located. In general, the additional data or the information which the additional data relate to can be of various kinds. For example, the information can relate to a locking system of the room or the hall, a room or hall monitoring system or a presence detector for persons.

The control of the production line can thus be made dependent on more information than can be provided by the sensor or the sensors that monitor the protected regions associated with the production line.

Further possible embodiments of the production line according to the invention are set forth in the following.

The sensor can be configured to capture images, in particular depth-resolved images, of the protected region and/or to detect intrusions into the protected region.

The sensor can, for example, be a camera, e.g. also a thermal imaging camera, a laser scanner, a radar sensor, a light barrier or a light grid. A plurality of sensors and combinations of different sensors can also be provided.

The sensor can be attached to a movable module or a movable component of a module or can be integrated into said movable module or movable component.

It can be provided that the sensor is attached or oriented such that a movable part, from which at least a potential danger emanates, of a module or of a component of a module is located in the background of the protected region and potentially endangered objects can enter the foreground of the protected region.

The control device can be configured to evaluate sensor data that are provided by a plurality of sensors that monitor either the same protected region or different protected regions.

In this respect, it can e.g. be provided that the sensors monitor the same protected region from different perspectives. Different protected regions can be separate from one another or can overlap one another.

The control device can comprise an evaluation device that is configured to evaluate the sensor data and to assess the special situation.

### BRIEF DESCRIPTION OF DRAWINGS

The invention will be described in the following by way of example with reference to the drawing. There are shown:

FIGS. 1a and 1b together schematically, in a side view, a possible embodiment example of a production line according to the invention that can be operated in a manner according to the invention;

FIG. 2 a scheme for explaining the method according to the invention; and

FIGS. 3, 4 and 5 possible embodiment examples of the invention using a section of a packaging machine that forms a part of a production line according to the invention.

### DETAILED DESCRIPTION

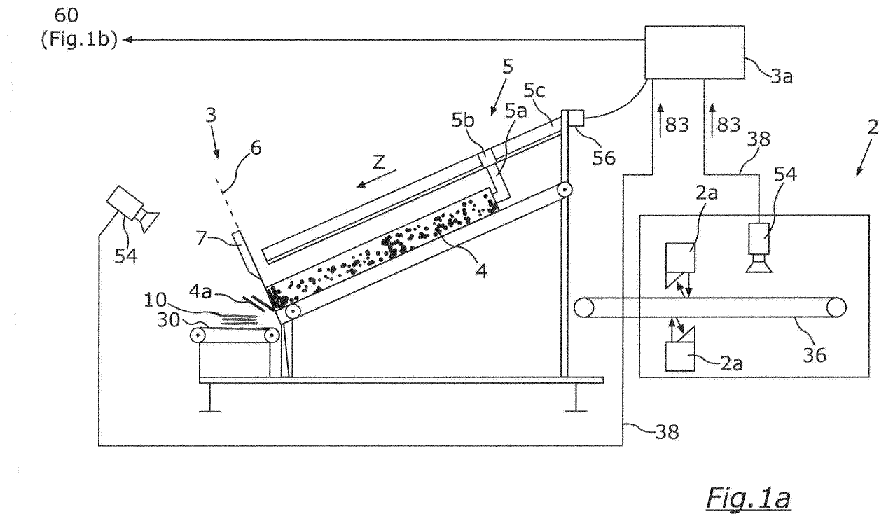

FIG. 1a shows, in a schematic side view, a possible embodiment example of a high-performance slicer 3 that, like the packaging machine 12 described below in connection with FIG. 1b, forms a component of a possible embodiment example of a production line 1 according to the invention.

A scanning apparatus 2 is arranged upstream of the slicer 3 and can comprise a scanner that, for example, works according to the light section method and that serves to determine the outer contour of products 4 to be sliced. Alternatively or additionally, the scanning apparatus 2 can comprise an X-ray scanner with which it is possible to determine the inner structure of products 4 to be sliced.

In the example shown schematically here, the products 4 are guided through a housing of the scanner 2 by means of a conveyor belt 36 prior to the slicing and are scanned by means of two scanning units 2a in so doing. The determination of the outer contour of the products 4 taking place in this way is generally known to the skilled person so that there is no need to go into more detail here.

In the slicer 3, a respective product 4 to be sliced rests on a product support 9a that is inclined relative to the horizontal and that comprises a driven or free-running endless belt or a stationary sliding surface for the product 4. The product support 9a can be configured in a generally known manner as a so-called loading rocker, which can be pivoted between the inclined position shown and a horizontal loading position, so that products 4 that come from the scanner 2 and that are fed by means of the conveyor belt 36 move onto the product support 4a and can then be brought into the inclined position in accordance with FIG. 1a by pivoting.

In this inclined position in accordance with FIG. 1a, a product holder 5a, which is, for example, configured as a gripper, can be brought into engagement with the rear end of the product 4. The product holder 5a can be moved in a feed direction Z, and indeed by means of a spindle drive that comprises a spindle nut 5b coupled to the holder 5a and a spindle 5c extending in the feed direction Z.

The product feed that is hereby formed feeds a respective product 4, which is disposed on the product support 9a, to a cutting plane 6 which extends perpendicular to the feed direction Z and in which a cutting blade 7 moves. The cutting blade 7 can be a scythe-like blade that rotates exclusively about an axis of rotation extending parallel to the feed direction Z. Alternatively, the cutting blade 7 can be a circular blade that rotates about an axis of rotation and additionally revolves in a planetary motion about a further axis, wherein these axes likewise extend parallel to the feed direction Z.

The cutting blade 7 consequently performs cutting movements, as a result of which slices 4a are cut off from the correspondingly fed product 4, and indeed at cutting speeds of, for example, several hundred to some thousand slices per minute.

The contour and/or structure determination by means of the scanner 2 serves to obtain information about the density distribution of the products 4. In addition, the products 4 are weighed by means of a scale (not shown) for this purpose. Alternatively, assumptions about the average product density can be used, e.g. in the form of values kept available in stored form.

Consequently, the thickness of a respective slice 4a and thus the weight of a slice 4a or of a portion 10 formed from a plurality of slices 4a can be predefined by controlling the product feed.

Such a slicing with an exact weight of food products 4 by means of a high-performance slicer 3 in order to obtain slices 4a and/or portions 10 of an exact weight, which are sold to end consumers by the food trade after the packaging in a packaging machine (cf. FIG. 1b), is generally known to the skilled person.

The portions 10 are formed from the falling cut-off slices 4a on a portioning belt 30. The formed portions 10 are transported away by means of the portioning belt 30 and are transferred to a transport path not shown in detail in FIG. 1a.

The operation of the scanner 2 and the slicer 3 is controlled by a control device 3a that is associated with the slicer 3 and that communicates with a control device 60, which is explained in more detail below, of the entire production line 1 or forms a component of this control device 60 (cf. FIG. 1b). However, such a separate control device 3a is not absolutely necessary. The scanner 2 and the slicer 3 can also each communicate directly with the central control device 60.

Via the aforementioned transport path, the portions 10 reach the packaging machine 12 shown in FIG. 1b and explained in more detail below.

A so-called feeder, of which two endless conveyor belts 13a, 13b are shown here, can be used to insert the portions 10 into the packaging machine 12. Alternatively, the insertion of the portions 10 can take place by one or more robots 50 that each comprise a gripper 49 for picking up and placing the portions 10, i.e. the robot 50 can in particular be a so-called picker. The insertion of the portions 10 into the packaging machine 12 takes place at an insertion station 13 of the packaging machine 12.

The packaging machine 12 that operates in a transport direction T comprises a machine frame 47. A transport chain 27, which is only schematically shown here at the upstream end of the machine, is guided at a left side frame and at a right side frame of the machine frame 47 in each case. The two transport chains 27 together form a transport device for a bottom film 23 drawn from a supply roll 23a.

The machine comprises a plurality of work stations, which follow one another in the transport direction T and which are synonymously also referred to as modules in the present disclosure, namely a molding station 11 also called a deep-drawing machine or a thermoforming machine in some applications, the aforementioned insertion station 13 for products 10 to be packaged, a feeding station 14 for a top film 25 drawn from a supply roll 25a, a labeling and/or printing station 16, a transverse separating station 17 and a longitudinal separating station 19.

The products 10 to be packaged are food products, here in the form of so-called portions, which each comprise a plurality of slices that—as explained above with reference to FIG. 1a—were cut off from a loaf-shaped or bar-shaped food, such as sausage, cheese, ham or meat, by means of a food slicer (not shown here). The scanner 2 and the slicer 3 in accordance with FIG. 1a and the packaging machine 12 are components of a production line 1 according to the invention.

The central control device 60 of the production line 1 controls the operation of the packaging machine 12, including the modules mentioned. As mentioned, the scanner 2 and the slicer 3 as well as all further modules of the production line 1 are also controlled by this central control device 60.

The packaging machine 12 is provided with an operating device 45 that e.g. comprises a touch screen at which all the necessary information can be displayed to an operator and the operator can make all the necessary settings before and during the operation of the machine.

The basic design and the basic mode of operation of the workstations mentioned are generally known to the skilled person so that they will not be discussed in detail here.

At the molding station 11, which comprises a top tool 11a and a bottom tool 11b, recesses 29, which are also designated as depressions, are formed in the bottom film 23 in a deep-drawing process in each case. The portions 10 mentioned are inserted into these recesses 29 at the insertion station 13. The insertion station 13 here comprises the aforementioned feeder comprising the two endless conveyor belts 13a, 13b, wherein, alternatively or additionally, the insertion station 13 can comprise the aforementioned picker robot 50. Said picker robot can e.g. be configured in the form of a delta robot comprising a gripper 49 that comprises two claws that together hold one portion 10 in each case. Such robots 50 and their use in the handling of foods, in particular when inserting portions 10 into recesses 29 of packages 21, are generally known to the skilled person so that further statements are not necessary here.

The bottom film 23 provided with the filled recesses 29 and the top film 25 are subsequently fed to the sealing station 15 that comprises a top tool 15a and a bottom tool 15b. The top film 25 and the bottom film 23 are connected to one another by means of these tools 15a, 15b. The recesses 29 and thus the packages 21 formed by the top film 25 and the bottom film 23 are hereby closed. Sealing points 43, also called sealing seams, extending transversely to the transport direction T are schematically indicated in FIG. 1a.

Subsequent to the sealing station 15, the packages 21 are still connected by the top film 25 and the bottom film 23 and therefore still have to be separated. In the embodiment example shown here, the packages 21 are provided with labels 54 and/or are printed at the labeling device 16 before the separation. The labeling and the printing can also take place in separate stations.

Further conveyor belts and/or work stations, for example a scale for checking the weight of the packages 21, can be provided downstream of the separating stations 17, 19.

Applications can e.g. differ from one another with respect to the kind of products 10 to be packaged, the size/shape of the recesses 29 in the longitudinal direction and/or the transverse direction or with respect to a format set. A format set here generally refers to a group of items, here in particular both portions 10 and recesses 29 or packages 21, that are handled as a whole—i.e. format set-wise—and that in particular differ from one another by the number and distance of items in the longitudinal direction and transverse direction.

Thus, e.g. per work cycle of the packaging machine 12, a packaging format or format set of 3×4 (3 in the transverse direction and 4 in the longitudinal direction) recesses 29 or product receivers of other kinds can be formed in the molding station 11, a format set of 3×4 correspondingly arranged products 10 can be inserted into a respective format set of recesses 21 at the insertion station 13, and a respective format set of 3×4 recesses 29 filled with products 10 can be sealed at the sealing station 15. The same applies to the labeling device 16.

An arbitrarily dimensioned N×M format set can generally be formed, where N>=2 and M>=1.

At the production line 1 shown in FIGS. 1a and 1b, and indeed at the scanner 2, at the slicer 3 and at the packaging machine 12, a plurality of sensors 54 are arranged that are each configured as a camera here. Each camera 54 monitors a protected region, not shown in detail here, that comprises a specific spatial region of the production line 1 and that is in particular associated with one of the modules.

In the embodiment example shown here, a protected region is associated with the region between the sealing station 15 and the labeling station 16. Furthermore, a camera 54 in each case monitors a protected region that is associated with the transverse separating station 17 or the longitudinal separating station 19.

A further camera 54 monitors the region between the insertion station 13 and the sealing station 15. A further protected region is associated with an insertion station 13. Furthermore, at the upstream end of the packaging machine 12, FIG. 1b shows a camera 54 that monitors a protected region that is associated with the region at which the bottom film 23 coming from the supply roll 23a comes into engagement with the aforementioned transport chains 27.

In FIG. 1a, a camera 54 is shown purely by way of example in the scanner 2 and monitors a protected region associated with the scanner 2. Furthermore, a protected region is associated with the portion formation region of the slicer 3 that is monitored by a further camera 54.

The cameras 54 communicate directly or via a separate control device, such as the control device 3a shown in FIG. 1a that is associated with the scanner 2 and with the slicer 3, and communicate with the central control device 60 via respective data transmission means 38. Sensor data 83 relating to the monitoring can hereby be provided for the control device 60 by the cameras 54 that are sensors within the meaning of the present disclosure.

The control device 60 has an evaluation device 61 that serves to evaluate the sensor data 83 and to assess a respective special situation.

The control device 60 of the production line 1 not only receives the sensor data 83 from the aforementioned cameras 54, but also receives additional data 83a via a sensor system 91 provided in addition to the cameras 54. This sensor system 91 can purely by way of example comprise a camera 91 attached to a hall ceiling 89, a device for monitoring the hall, a locking system of the hall or a presence detector of the hall. At least some of these devices 91 can e.g. be attached to a hall wall 90.

The additional data 83a provided by this additional sensor system 91 relate to information about the environment of the production line 1. Further additional data 83a can be made available to the control device 60 by further sensors 56 that—unlike the cameras 54 mentioned—do not monitor a protected region. These additional sensors 56 can, for example, be arranged downstream of the packaging machine 12 and can e.g. be associated with a device for the final inspection of the finished packages 21 or with a device for packaging the packages 21 ready for shipment.

At the upstream conveyor 13b of the aforementioned feeder, it is shown purely by way of example in FIG. 1b that such an additional sensor 56 can also be associated with a respective conveying device of the transport path. In FIG. 1a, an additional sensor 56 is associated purely by way of example with the slicer 3, and indeed in the region of the upstream end of the spindle 5c of the product feed.

By means of such additional sensors 56, the control device 60 can, for example, be provided with measured values of basically any parameters that are relevant for the operation of a respective production line 1.

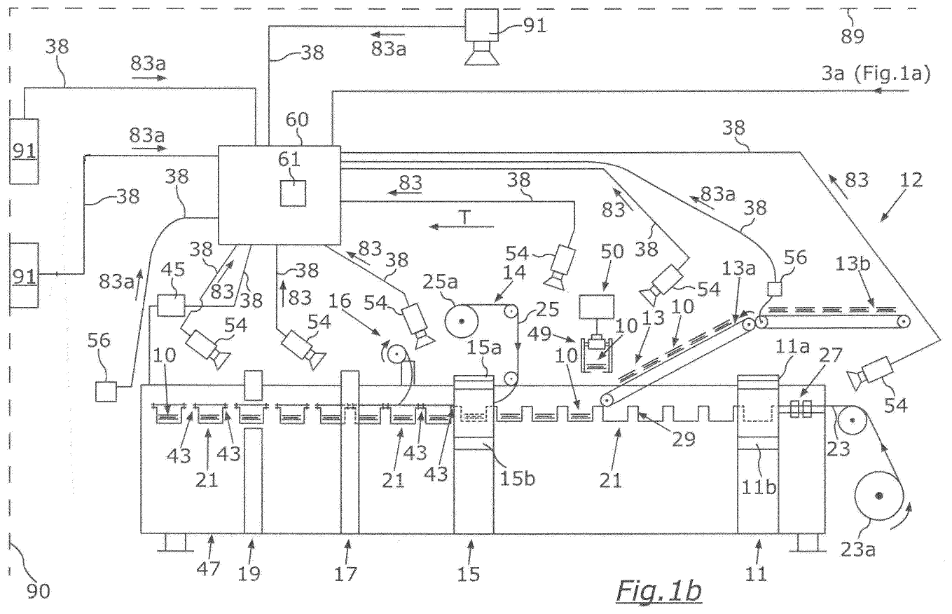

FIG. 2 shows the above-explained production line 1 in schematic form, and indeed in particular with respect to the infrastructure comprising the aforementioned cameras 54 and additional sensors 56 as well as the central control device 60.

The production line 1 is schematically shown in FIG. 2 by its individual modules 1a. The production line 1 comprises the scanner 2 and the slicer 3 (cf. FIG. 1a) as well as the packaging machine 12 (cf. FIG. 1b). The aforementioned transport path 76, of which the endless conveyor belts 13a, 13b of the feeder are shown in FIG. 1b, is located between the slicer 3 and the packaging machine 12.

Modules 74 for product preparation are connected upstream of scanner 2. These modules can, for example, comprise a cheese divider or a bacon press.

Furthermore, the production line 1 comprises modules that are connected downstream of the packaging machine 12 and that can comprise a final inspection module 78, for example a so-called end-of-line scale, and a module 80 for packaging the finished packages 21.

Each of these modules 1a can be assigned at least one sensor in the form of one of the aforementioned cameras 54. However, this is not compulsory. Purely by way of example, only one additional sensor 56, but no camera 54, is provided for one of the product preparation modules 74 and for the final inspection module 78 in each case. Thus, it is illustrated by FIG. 2 that not every module 1a of a production line 1 must be assigned a protected region that is monitored by means of a sensor, e.g. in the form of a camera 54.

Furthermore, one or more additional sensors 56 can be assigned to the individual modules 1a. It is shown purely by way of example for one of the product preparation modules 74 that it is not assigned an additional sensor, but rather only a sensor configured in the form of a camera 54 for monitoring a protected region associated with this product preparation module 74.

The individual sensors 54, 56 can communicate directly with the control device 60 to provide the respective sensor data or additional data for the control device 60. As shown, however, so-called station-internal control devices 72 can be provided for at least some of the modules 1a and can take over certain control tasks for the respective module 1a.

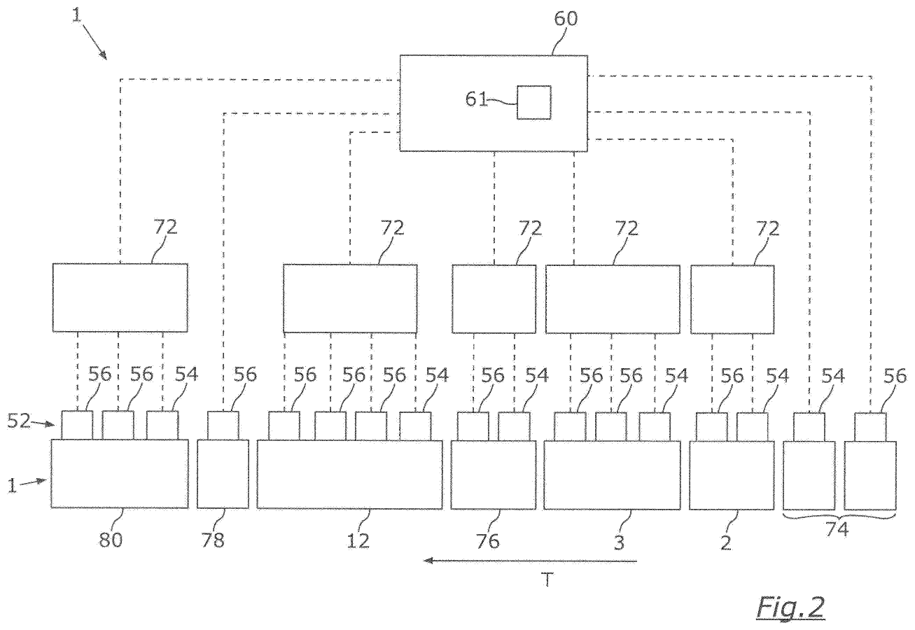

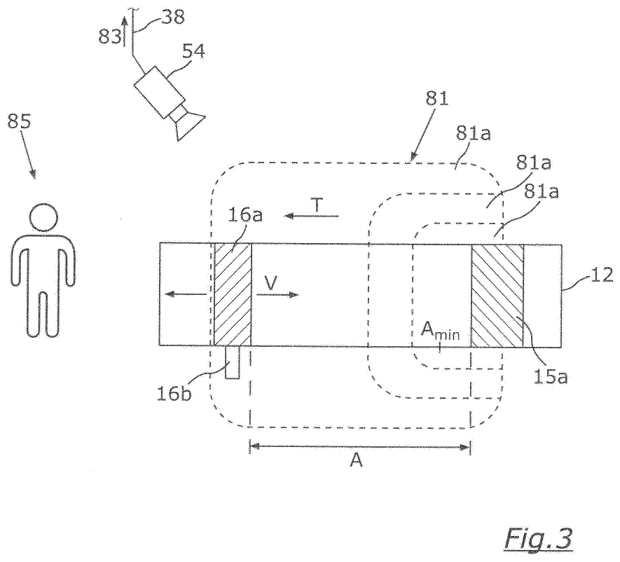

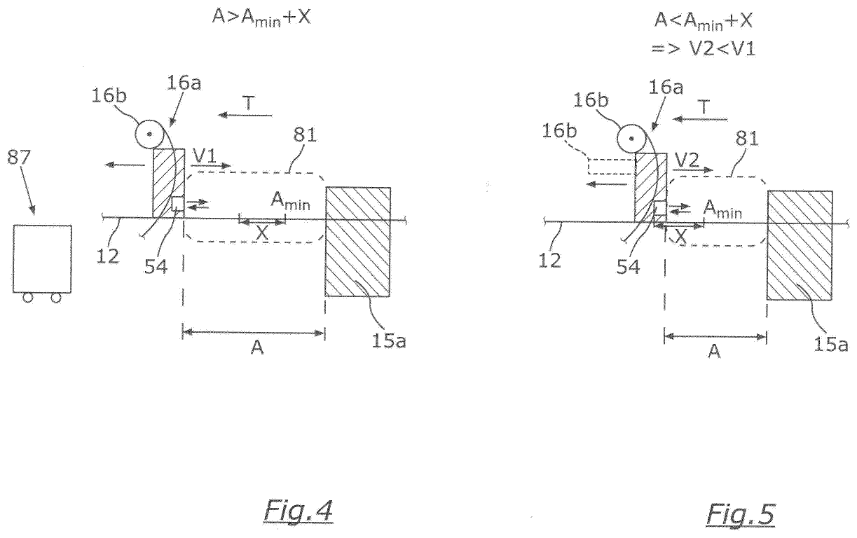

FIGS. 3, 4 and 5 each show a section of the packaging machine 12 shown in FIG. 1b. A region between the top labeler 16a, which forms a component of the labeling station 16, on the one hand, and the top tool 15a of the sealing station 15, on the other hand, is in each case shown (in a plan view in FIG. 3 and in a side view in FIGS. 4 and 5 in each case). The sealing station 15, including the top tool 15a, is arranged in a stationary manner with respect to the transport direction T during the operation of the packaging machine 12. The top labeler 16a provided with a label supply roll 16b—as well as the bottom labeler of the labeling station 16 that is not shown here—can be moved in both directions at a speed v with respect to the transport direction T, as is indicated by the two arrows in each case. The top labeler 16a serves to apply labels to the top film 25. Accordingly, the bottom labeler, not shown, of the labeling station 16, serves to apply labels to the bottom film.

The explanations of embodiment examples of the invention given here as an example in connection with a labeling station 16 or the top labeler 16a apply analogously to other modules or components that are movable relative to one another—not only of the packaging machine 12, but, depending on the specific embodiment, also to other units of the entire production line 1. For example, the component 16a shown in FIGS. 3, 4 and 5 can, in an alternative embodiment, also be a printing device that is movable in and against the transport direction T and that serves to print the packages or the labels applied to the packages.

According to FIG. 3, a spatial protected region 81 is assigned to the aforementioned region between the top labeler 16a and the top tool 15a and is ultimately defined in terms of software and thus virtually by the control device 60 or its evaluation device 61 such that everything located outside the protected region 81 is not considered, even if the camera 54 monitoring the protected region 81 has a field of view that extends beyond the protected region 81 at least in some spatial directions. The protected region 81 is defined as a volume that includes everything that is relevant for a respective monitoring task. Alternatively, everything in the field of view of the cameras 54 can form the protected region 81.

In the embodiment example shown here, the protected region 81 is divided into three protected zones 81a. Since the top tool 15a—as mentioned—is stationary and the top labeler 16a thus moves along the packaging machine 12 relative to the top tool 15a, the protected zone 81a at the right in FIG. 3 can be referred to as the inner or innermost protected zone 81a. The protected zone 81a at the left in FIG. 3 then represents an outer protected zone 81a in this regard.

The distance between the top labeler 16a and the top tool 15a measured along the transport direction T is labeled A in FIG. 3. In this example, a minimum distance Amin is specified within the meaning of a gap dimension that may not be fallen below during the operation of the packaging machine 12, for example, due to legal regulations. In other words, the top labeler 16a may not come closer to the top tool 15a than the minimum distance Amin.

On the movement of the top labeler 16a during the operation of the packaging machine 12, due to a position control of the top labeler 16a, the control device 60 is able to control the top labeler 16a such that the predefined minimum distance Amin is maintained in a normal operation. In this normal operation, the camera 54 therefore does not serve for a closed-loop control such that the movement of the top labeler 16a takes place within the meaning of an avoidance of the falling below of the minimum distance Amin.

Rather, the camera 54 together with the control device 60 ensures that the top labeler 16a can be moved back and forth at an intended maximum speed during the normal operation, as long as no intrusion into one of the protected zones 81a of the protected region 81 is recognized.

If, for example, a person 85 comes so close to the packaging machine 12 in this region during the operation that an intrusion into the outer protected zone 81a takes place, this person 85 or a body part of this person 85 is recorded by the camera 54 as an object in the outer protected zone 81a. Based on the corresponding sensor data, the control device 60 recognizes a special situation therein.

If, based on certain criteria, such as those mentioned in the introductory part of the present disclosure, the control device 60 comes to the conclusion during the assessment that this person 85 or their body part does not represent a permissible object in the outer protected zone 81a, this is assessed as a hazardous situation. Then, the control device 60 basically also maintains the operation of the packaging machine 12 with respect to the movement of the top labeler 16a, but slows down the travel speed of the top labeler 16a. For it is possible that, during the further operation, the top labeler 16a comes so close to the top tool 15a that the minimum distance Amin is fallen below, which would not be critical for the operation of the packaging machine 12, but could pose a risk of entrapment for the person 85.

The travel speed v of the top labeler 16a can be further reduced if it is recognized that the person 85 or their body part is now in the middle protected zone 81a. The top labeler 16a or the entire packaging machine 12 or the entire production line 1 can further be stopped by the control device 60 as an “ultima ratio” if, based on the sensor data of the camera 54, the control device 60 detects an intrusion into the inner protected zone 81a, which is assessed as an emergency situation.

Consequently, the production line 1 is only shut down if there is actually an emergency situation (violation of the inner protected zone 81a). If there is only a potential danger to a person 85 (violation of the outer or middle protected zone 81a), the production line 1 can continue to be operated. The slowed-down operation is advantageous compared to a standstill, as already explained elsewhere.

Due to this monitoring according to the invention, the production line 1 can be operated with an increased output in normal operation, if there is no violation of one of the protected zones 81a, compared to production lines 1 belonging to the prior art since—as explained—the top labeler 16a can be moved at a high speed that utilizes the technical possibilities. Furthermore, it can be provided that the minimum distance Amin mentioned may be fallen below in such a normal operation.

In the embodiment example of FIGS. 4 and 5, a camera is not provided as the monitoring sensor, but rather a distance sensor 54 that can measure the distance from objects that are disposed along the direction of travel of the top labeler 16a in a direction opposite to the transport direction T. In the embodiment example shown here, such an object is the top tool 15a. This embodiment example illustrates that the sensor 54 serving for the monitoring of a protected region 81 does not have to be a camera for recording images of the protected region 81.

As long as the measured distance A is greater than the sum of the predefined minimum distance Amin and a safety margin x, as shown by way of example in FIG. 4, the control device 60 operates the top labeler 16a at a high travel speed v1. This ensures a high-performance operation.

If the measured distance A corresponds to the sum of Amin and X or falls below it (FIG. 5), this is recognized by the control device 60 as a special situation in the protected region 81 based on the sensor data provided by the distance sensor 54 and is, for example, always assessed as a critical situation regardless of other circumstances, said critical situation leading to an adjustment of the travel speed of the top labeler 16a within the meaning of a slowing down. The top labeler 16a is then moved at a reduced speed v2<v1.

With this concept, the top labeler 16a is therefore moved comparatively slowly when it—defined by the minimum distance Amin and the safety margin X—is in the vicinity of the top tool 15a.

Such a movement adaptation can be even more differentiated if the protected region 81—in this regard as in the example of FIG. 3—is divided into different protected zones 81a. The slowing down can then be all the greater the closer the top labeler 16a comes to the top tool 15a.

A further situation-adaptive control can take place by making the magnitude of the safety margin X dependent on the respective specific situation. For example, the magnitude of X can be increased within the meaning of an increase of the safety if a person 85 (cf. FIG. 3) or another external object, such as an external object in the form of a conveyor vehicle 87 (cf. FIG. 4) moving in the region of the production line 1, is located in the vicinity of the production line 1. Even if such an object cannot reach into the region between the top labeler 16a and the top tool 15a like a person 85, a safety concept for the operation of the production line 1 can provide that an increased risk potential can nevertheless be assumed if external objects of any kind are located in the region of the production line 1, or at least in the region of the respective monitored protected region 81.

The presence of such an object 85, 87 can be determined by a further sensor. This further sensor can be a camera that is attached to the respective section of the packaging machine 12 to which a corresponding further protected region is assigned. Alternatively, such external objects can be detected, for example, by a hall sensor 91, in particular in the form of a camera, that is attached to the hall ceiling 89 (cf. FIG. 1b).

The size of the safety margin X can also be made dependent on further conditions. For example, it can be recognized by a sensor, not shown here, integrated into the top labeler 16a or by a further camera whether a label supply roll 16b of the top labeler 16a is in a normal operating position or in a laterally folded-down maintenance position that is indicated by dashed lines in FIG. 5.

In the maintenance position, the supply roll 16b can project comparatively far laterally outwardly so that it represents a potential hazard for the corresponding region at the packaging machine 12. If an operation of the packaging machine 12, and thus of the production line 1 as a whole, is still possible in this maintenance position, the control device 60 can consequently also move the top labeler 16a with the supply roll 16b folded down to the side along the packaging machine 12 in the intended manner. Due to the increased hazard potential when the supply roll 16b is folded down, the control unit 60 can in this respect increase the safety margin X so that a slowing down of the movement of the top labeler 16a already occurs at larger measured distances A.

The examples explained above make it clear that the invention enables an operation of the production line 1 with a high performance if it is ensured that there is no or at least no relevant safety risk, wherein a maximum safety is, however, simultaneously ensured since the control device 60 can flexibly react to situation changes that can be recognized and assessed by means of the sensor-based monitoring of protected regions 81 and, if necessary, by considering additional information that is provided by further sensors or other sources.

According to some possible embodiment examples of the invention, the packaging machine or a labeling station of the packaging machine can be configured such as is disclosed in the German patent application DE 10 2023 110 423.3 that was filed with the German Patent and Trademark Office on Apr. 24, 2023. The content of this patent application, at least insofar as it relates to the packaging machine disclosed therein and the labeling device disclosed therein, in each case with respect to all the further developments described, is hereby incorporated by reference. The packaging machine of the production line disclosed herein can consequently be configured and operated such as is disclosed in the mentioned patent application DE 10 2023 110 423.3. Furthermore, the labeling station of the packaging machine disclosed herein of the production line can be designed and operated such as is disclosed in the mentioned patent application DE 10 2023 110 423.3 with reference to the labeling device.

The packaging machine disclosed in the mentioned patent application DE 10 2023 110 423.3 can consequently be operated as part of a production line disclosed herein in accordance with any one of the methods disclosed herein. Furthermore, the labeling device disclosed in the mentioned patent application DE 10 2023 110 423.3 can be operated as part of a packaging machine disclosed herein in accordance with any one of the methods disclosed herein.

### REFERENCE NUMERAL LIST

1 production line
1a module
1b component
2 scanning apparatus, scanner
2a scanning unit
3 slicing apparatus, slicer
3a control device
4 food product
4a slice
5 product feed
5a product holder
5b spindle nut
5c spindle
6 cutting plane
7 cutting blade
9a product support
10 portion
11 molding station
11a top tool
11b bottom tool
12 packaging machine
13 insertion station
13a endless conveyor belt
13b endless conveyor belt
14 feeding station
15 sealing station
15a top tool
15b bottom tool
16 labeling station
16a component (top labeler of the labeling station)
16b label supply roll
17 transverse separating station
19 longitudinal separating station
21 package
23 bottom film
23a supply roll
25 top film
25a supply roll
27 transport chain
29 recess
30 portioning belt
36 conveyor belt
38 data transmission means
43 sealing point
45 operating device
47 machine frame
49 gripper
50 robot
54 sensor, camera
56 sensor
58 scale
60 control device
61 evaluation device
72 station-internal control device
74 product preparation module
76 transport path
78 final inspection module
80 final packaging module
81 protected region
81a protected zone
83 sensor data
83a additional data
85 person
87 external object, conveyor vehicle
89 hall ceiling
90 hall wall
91 sensor system
Z feed direction
T transport direction
V speed
A measured distance
Amin minimum distance
X safety margin

1. A method for operating a production line which comprises one or more modules and in which:
food products are cut into slices,
portions are formed from one or more slices and
the portions are packaged,
and said production line at least comprises:
a slicing apparatus for slicing the food products and for forming the portions;
a packaging machine for packaging the portions;
a transport path for handling the portions located between the slicing apparatus and the packaging machine;
a control device; and
at least one sensor for monitoring at least one protected region associated with the production line,
wherein the at least one sensor provides sensor data relating to the monitoring to the control device, and
wherein the control device recognizes a special situation in the at least one protected region based on the sensor data, performs an assessment of the special situation and, depending on a result of the assessment, performs a movement adaptation of at least one module or of at least one component of a module of the production line.

2. A method according to claim 1,
wherein the at least one protected region is fixed or variable relative to the production line.

3-5. (canceled)

6. A method according to claim 1,
wherein the special situation is a hazardous situation in which a person or an object belonging to the production line or an external object not belonging to the production line is exposed to potential danger by the module or by a component of the module of the production line.

7. (canceled)

8. A method according to claim 1,
wherein the special situation is recognized when a predefined minimum distance between parts of the production line that are movable relative to one another is not maintained in the at least one protected region.

9. A method according to claim 1, wherein an entry of an object into the at least one protected region is recognized as the special situation.

10. A method according to claim 1,
wherein the assessment of the special situation takes place in dependence on at least one of:
one or more additional predefined conditions, or
whether at least one predefined situation has been recognized in the at least one protected region or in another protected region.

11. A method according to claim 1, wherein at least one additional predefined criterion is considered for the assessment of the special situation.

12. A method according to claim 1,
wherein a plurality of operating modes are predefined for the at least one module or the at least one component of the module, and
wherein the movement adaptation takes place in that the control device initiates a change from a current operating mode to another operating mode of the module or the at least one component.

13. A method according to claim 1,
wherein the control device reverses the movement adaptation as soon as the special situation is no longer recognized, or
wherein the control device reverses the movement adaptation with a delay after the special situation is no longer recognized.

14. (canceled)

15. A method according to claim 1,
wherein the movement adaptation is a slowed-down movement.

16. A method according to claim 1,
wherein the movement adaptation takes place in that a movement sequence of the module or of the at least one component of the module is changed,
wherein the movement sequence forms part of an intended operation of the module or of the at least one component.

17. A method according to claim 1, wherein the movement adaptation takes place such that:
a speed or an acceleration of a movement of the module or of the at least one component of the module is reduced or increased; or
at least a minimum distance that is to be maintained between parts moved relative to one another is increased.

18. (canceled)

19. A method according to claim 1,
wherein the at least one protected region is divided into a plurality of protected zones and, depending on which protected zone or which protected zones is/are affected by a recognized special situation, the special situation is assessed differently or the movement adaptation is performed differently.

20. A method according to claim 1, wherein the movement adaptation takes place in dependence on at least one of:
a position of an object in the at least one protected region;
a distance of the object located in the at least one protected region from the production line, from the module, or from the at least one component of the module;
a speed of the object in the at least one protected region; or
a direction of a movement of the object in the at least one protected region relative to the production line.

21-22. (canceled)

23. A method according to claim 1,
wherein the at least one sensor comprises a plurality of sensors for monitoring a common protected region of the at least one protected region and the special situation in the common protected region is assessed based on the sensor data of the plurality of sensors, or
wherein the at least one sensor comprises the plurality of sensors for monitoring different protected regions of the at least one protected region and for monitoring either:
a first special situation in one of the different protected regions, or
a second special situation relating to a plurality of the different protected regions is assessed as an overall situation based on the sensor data of the plurality of sensors.

24-25. (canceled)

26. A production line in which:
food products are cut into slices,
portions are formed from one or more slices, and
the portions are packaged,
the production line comprising:
a slicing apparatus for slicing the food products and for forming the portions;
a packaging machine for packaging the portions;
a transport path for handling the portions located between the slicing apparatus and the packaging machine;
a control device; and
at least one sensor for monitoring at least one protected region associated with the production line,
wherein the at least one sensor is configured to provide sensor data relating to the monitoring for the control device, and
wherein the control device is configured to:
recognize a special situation in the at least one protected region based on the sensor data,
perform an assessment of the special situation, and
depending on a result of the assessment, adapt a movement of at least one module or of at least one component of the at least one module of the production line.

27. A production line according to claim 26,
wherein the at least one sensor is configured to detect at least one of images of the at least one protected region, depth-resolved images of the at least one protected region, or intrusions into the at least one protected region.

28. A production line according to claim 26,
wherein the at least one sensor is attached to a movable module or a movable component of the at least one module, or
wherein the at least one sensor is integrated into the movable module or the movable component.

29. A production line according to claim 26,
wherein the at least one sensor is attached or oriented such that a movable part of a module or of the component of the module from which a potential danger emanates is located in a background of the at least one protected region and potentially endangered objects can enter a foreground of the at least one protected region.

30-31. (canceled)

32. A method according to claim 15,
wherein the slowed-down movement is always maintained above zero unless a predefined emergency situation is recognized in which the control device stops the production line or the at least one module of the production line.
